(19) United States
(12) Patent Application Publication
(10) Pub. No.: US 2015/0078399 A1
(43) Pub. Date: Mar. 19, 2015

(54) Method and Apparatus for Consistent Modification of the Schedules in a Time-Controlled Switch

(71) Applicant: FTS Computertechnik GmbH, Vienna (AT)

(72) Inventors: Stefan Poledna, Klosterneuburg (AT); Harald Angelow, Vienna (AT); Wilfried Steiner, Vienna (AT); Martin Schwarz, Wiener Neustadt (AT)

(21) Appl. No.: 14/395,256

(22) PCT Filed: Apr. 19, 2013
(86) PCT No.: PCT/AT2013/050095

§ 371 Date: Oct. 17, 2014

(30) Foreign Application Priority Data
Apr. 19, 2012 (AT) A475/2012

(51) Int. Cl. H04J 3/06; H04L 12/937

(52) U.S. Cl. CPC H04J 3/0655; H04L 49/254; H04L 49/557
USPC 370/419

(57) ABSTRACT

The invention relates to a method for dynamic modification of the schedules in a time-controlled switch for relaying time-controlled messages in a real-time computer system, wherein at least one active schedule and at least one new schedule are stored at a point in time in a switch, wherein, at a specified changeover time in the active interval of a sparse time base, the active schedule is deactivated and a new schedule is activated.

### FIELD OF THE INVENTION

The invention relates to a method for dynamic modification of the schedules in a time-controlled switch for relaying time-controlled messages in a real-time computer system.

The present invention lies in the field of computer technology. The invention describes an innovative method for consistently modifying, in a time-controlled real-time system, the schedules in a communication system.

### INTRODUCTION

In a distributed real-time system, for example the smart grid, in which periodic sensor data has to be transmitted over long physical distances, the transmission duration between the decentral sub-systems and the central control room determines, to a significant extent, the dead time of a control circuit closed via the communication system and therefore the quality of the control. The transmission times can be minimised when, in a time-controlled network, the times of data capture, the transmission, the relaying by the switches, and the processing with use of a schedule based on a global time are synchronised in such a way that no waiting times of the messages occur in the communication system. A schedule specifies the periodically recurring times at which a time-controlled action, for example the transmission of a message, is to be performed by a switch.

When an anomaly occurs in a distributed facility, such as the smart grid, it is thus often necessary to monitor more closely the remote sub-system in which the anomaly occurred. For this purpose, the currently active schedule of the transmission has to be replaced by a new schedule, which enables the close monitoring of the sub-system in which the anomaly occurred. The critical control circuits necessary for maintaining the network quality must continue to be continuously supported in this new schedule.

A changeover from an active schedule to a new schedule is referred to as consistent when all critical time requirements sent to the communication system in the new schedule are satisfied and when there is no phase shift of a periodic message, which is sent both in the active and in the new schedule, within the scope of the changeover.

When the changeover is inconsistent, a fault may thus occur in the application that at least adversely affects the quality of the application. When, for example in a distributed multimedia system, in which audio and video signals are transmitted, the changeover from one camera to another camera leads to a phase shift in the audio signal, a temporary fault thus occurs in the acoustic playback, which reduces the quality of the audio playback.

### OBJECT OF THE INVENTION

The object of the invention is to disclose a method for generating, in a distributed time-controlled real-time system, new schedules for the time-controlled switches and for finding consistent changeover points at which these new schedules have to be activated so that the system as a whole can be harmonically transferred from the active schedule into the new schedule.

This object is achieved with a method of the type mentioned in the introduction in that, in accordance with the invention, at least one active schedule and at least one new schedule are stored at a point in time in a switch, wherein, at a specified changeover time in the active interval of a sparse time base, the active schedule is deactivated and a new schedule is activated.

Due to the changeover in the active interval of the sparse time base, a consistent changeover to a new schedule occurs in the switches.

The methods described in the literature for establishing schedules for time-controlled communication systems [3-5] do not detail the creation of a consistent changeover time of schedules.

### SUMMARY OF THE INVENTION

The present invention discloses an innovative method for generating, in a distributed time-controlled real-time system, new schedules for the time-controlled switches and for finding consistent changeover times at which these new schedules must be activated so that the system as a whole can be harmonically transferred from the active schedule into the new schedule.

The invention also relates to a switch (distribution unit) for use in an above-described method, wherein the switch is preferably configured to deactivate an active schedule and to activate a new schedule at a specified changeover time in the active interval of a sparse time base.

The invention additionally relates to a real-time system for carrying out an above-described method.

Further advantageous embodiments of the invention and in particular of the method according to the invention are described hereinafter and can be provided additionally, alternatively or in any combination with one another. Here, it may be that
a new passive schedule is loaded whilst an active schedule is executed in the switch;
in a number of connected switches, all switches access a common global time base of known precision;
the common global time base is fault-tolerant;
time-controlled actions in the switch are performed only during the active phases of the global sparse time base;
a dynamic on-line scheduler generates a new schedule on the basis of the requirement of a user;
the new schedule is loaded into the switch with use of cryptographic protocols to secure the authenticity and integrity of the new schedule by a system that generates the schedule;
the scheduler (160) is implemented as a TMR system, wherein a switch only performs a changeover when at least two of three messages received by the TMR system are identical;
the schedules are stored in the switch with use of fault-identifying codes;
the schedules are stored in the switch with use of fault-correcting codes;
the phases of messages that run via a number of switches are synchronised in a schedule with use of the global time, such that a minimal end-to-end transport time of the message through the entire communication system is achieved;
the different periods in a schedule are arranged in a harmonic relationship relative to one another such that the longest period is the smallest common multiple of all periods;
a distinguished period of the number of harmonic periods corresponds to the physical second;
a distinguished period of the quantity of harmonic periods corresponds exactly to an interval that is predefined by an application;
in a number of connected switches that have a common global time base, the changeover points of the schedules in all switches are simultaneous;
the changeover points are selected such that, with messages that occur in the active and new schedule with the same period, no phase shift is caused by the changeover;
the switch checks whether, in a new schedule, messages classified as safety-critical are included in accordance with the safety-critical requirements, and, if this is not the case, the switch does not perform a changeover from the active to the new schedule and transmits a fault message to a diagnosis system;
the messages correspond to the SAE standard AS6802 of TT Ethernet;
the messages correspond to the IEEE Standard 1588 for precision clock synchronisation.

### BRIEF DESCRIPTION OF THE DRAWING

The present invention will be explained in greater detail on the basis of the following drawing, in which

FIG. 1 shows the structure of a distributed real-time system with five end systems and two switches, and

FIG. 2 shows a cyclical illustration of the progress of real time.

### DETAILED DESCRIPTION OF THE INVENTION

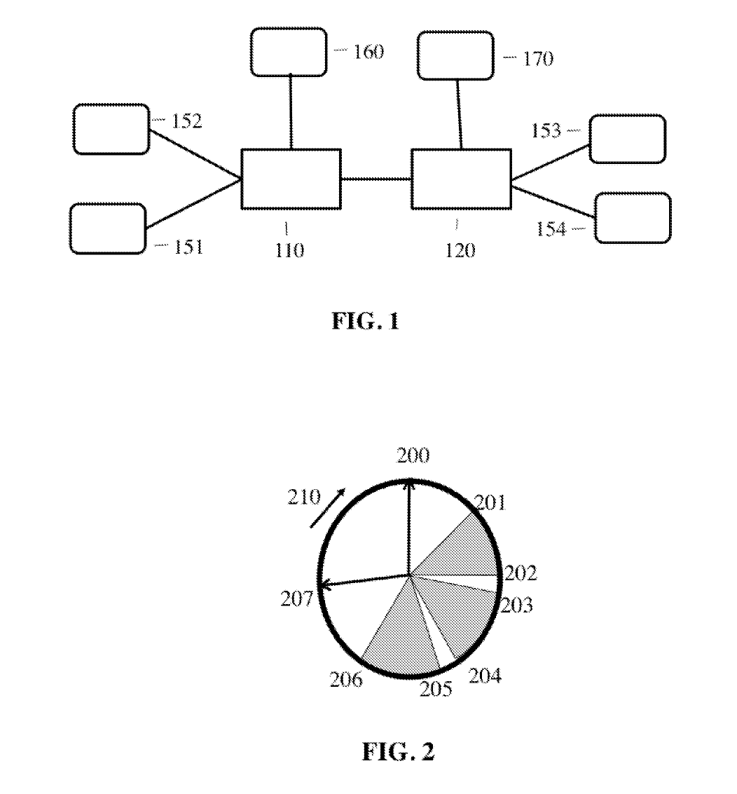

FIG. 1 shows a time-controlled real-time system having two time-controlled switches 110 and 120, four end systems 151, 152, 153, 154, a scheduler system 160 for calculating new schedules and a diagnosis system 170. All systems are connected via the bidirectional lines, illustrated in FIG. 1, for transmission of time-controlled and event-controlled Ethernet messages in accordance with the TTEthernet standard [7]. In accordance with this standard, time-controlled (time-triggered, TT) and event-controlled (event-triggered, ET) Ethernet messages can be transmitted in a real-time communication system. All systems of FIG. 1 have access to a fault-tolerant global time base of known precision. This time base is established in accordance with the IEEE standard 1588 for precision clock synchronisation. By means of this time base, a sparse time (as described in detail in [6, p.62-65]) is configured in the system as a whole so that all events in the system in the active intervals of the sparse time can be ordered consistently. In accordance with the invention, time-controlled actions in the system as a whole are performed only in the active intervals of the sparse time.

One active schedule and two or more new schedules are located in the switches 110 and 120 during operation at any moment in time. Before a new schedule is activated, it is passive and does not play any role in the course of the current communication.

FIG. 2 shows a cyclical illustration of the progress of real time. In this illustration, the progress of real time is illustrated in the form of periods and phases, In FIG. 2 time proceeds in the clockwise direction 210. The start of a period is synchronised at the time 200 with the global time. An event that occurs within a period (for example the event 201) is characterised by the specification of the angle, that is to say the phase, between the start of the period 200 and the event 201. When the time has passed through a full period—that is to say an angle of 360 degrees—the subsequent period thus starts. In the subsequent period, the time-controlled actions have the same phase as in the previous period. A phase shift occurs when the phase of a periodic action in the subsequent period is different from that in the previous period. The cyclical image of the progress of real time is particularly well suited for illustrating periodic processes as occur in time-controlled real-time systems.

The transport of a message from the end system 151 to the end system 153 of FIG. 1 will be considered hereinafter. When the end system 151 detects process data at the time 200, the pre-processing of the data in the system 151 lasts until the time 201. At the time 201, a message is sent to the switch 110 with the process data detected at the time 200 by the system 151. This message arrives at the switch 110 at the time 202. The message is forwarded from the switch 110 at the time 203 to the target address via the switch 120. The message arrives at the switch 120 at the time 204 and is forwarded from the switch 120 at the time 205 to the end system 153. The message arrives at the end system 153 at the time 206, where it is checked, and a new control value is output to the process at the time 207. In this example, the interval from 200 to 207 determines the part of the dead time caused by the distributed computer system. Due to the synchronisation of the events of the transmission and receipt of the messages in a time-controlled communication system and the a priori provision of the necessary capacity of the communication channels, the end-to-end transport times of the messages are minimised and waiting times in the communication system are prevented. In the intervals not occupied by the grey areas in FIG. 2, other messages, for example ET messages, can be transported in the communication system.

When an end user wishes to additionally transmit other real-time data, the end user thus sends a corresponding request to the scheduler 160 by means of an ET message. The scheduler 160 creates new schedules and sends these in a cryptographically secured ET message to the switches 110 and 120. The switches 110 and 120 check these messages in order to ensure the authenticity and integrity thereof and activate the new schedule at a changeover time predetermined precisely by the scheduler 160. In the present example of FIG. 2, the time 200 is offered as a changeover time, since a new period starts at this changeover time 200. In accordance with the invention, a new schedule can also be stored previously in the switch. The scheduler 160 then determines only the precise changeover time from the active schedule to the new schedule. The scheduler 160 can be implemented as a TMR system [6, p. 135], such that a switch in the fault-free case obtains three identical new schedules with the identical changeover times in a cryptographically secured manner. A switch only performs the scheduled changeover when at least two of the three schedules have identical content, in order to tolerate a fault in the case of schedule creation.

The creation of a schedule by the scheduler 160 is significantly facilitated and accelerated when the different periods in a schedule are arranged in a harmonic relationship relative to one another [9, p. 9] such that the longest period is the smallest common multiple of all periods. In such a harmonic schedule, a distinguished period is freely selectable, whereas all other periods are dependent on this freely selected period. In accordance with the invention, this distinguished period may be the physical second or a key interval, which is predefined by the specific application.

When, in a system, some messages occur in the active and new schedule with the same period and the same phase position, no phase is therefore to be caused between two of these messages due to the changeover. This is achieved in a harmonic schedule when the changeover occurs at the start of the longest period in all switches simultaneously. Simultaneity is then given in a system that supports a sparse time when actions are performed within the same active interval of the sparse time. Absolute simultaneity of remote actions cannot be achieved in principle in a distributed computer system.

When, in a system, safety-critical messages have to be transported, wherein the periods and phases of these safety-critical messages have been checked within the scope of a certification of the system, the periods and phases of these safety-critical messages thus may not be changed in any schedule. In such a situation, the switch checks whether all safety-critical requirements of the schedule are met in a new schedule. When this is not the case, the switch does not perform a changeover from the active to the new schedule and sends a fault message to the diagnosis system 170.

The active and new schedules can be stored in the switch with use of fault-identifying codes or fault-correcting codes.

The method disclosed here for consistent changeover of schedules in a distributed time-controlled real-time system improves the flexibility and quality and therefore the field of application of the time-controlled communication and therefore brings large economic advantages.

The present invention discloses an innovative method for generating, in a distributed time-controlled real-time system, new schedules for the time-controlled switches, and for finding consistent changeover times at which these new schedules have to be activated so that the system as a whole can be harmonically transferred from the active schedule into the new schedule.

### Cited Literature

[1] U.S. Pat. No. 5,694,542 Kopetz, H. Time-triggered communication control unit and communication method. Granted Dec. 2, 1997.

[2] U.S. Pat. No. 7,839,868. Kopetz, H. Communication method and system for the transmission of time-driven and event-driven Ethernet messages. Granted Nov. 23, 2010.

[3] US 20100220744, Ungerman, J., Intelligent Star Coupler for time-triggered communication protocol and method for communicating between nodes with a network using a time triggered protocol. Publication Date Sep. 2, 2010.

[4] US 20060242252, Jiang, S., Extensible Scheduling of Messages on Time-Triggered Busses. Publication Date Oct. 26, 2006.

[5] US 20110066854; Poledna, S., Method for Secure Dynamic Bandwidth Allocation in TT Ethernet. Publication Date Mar. 17, 2011

Kopetz, H. Real-Time Systems, Design Principles for Distributed Embedded Applications. Springer Publishing House. 2011.

[7] SAE Standard AS6802 von TT Ethernet. URL: http://standards.sae.org/as6802

IEEE 1588 Standard for a Precision Clock Synchronization Protocol for Network Measurement and Control Systems. URL: http://www.ieee1588.com/

[9] Kopetz, H., The complexity challenge in embedded system design, Proc. of ISORC, May 2008. pp. 3-12, IEEE Press.

1. A method for the dynamic modification of the schedules in a time-controlled switch for relaying time-controlled messages in a real-time computer system, the method comprising steps of:
storing at least one active schedule and at least one new schedule at a point of time in a switch;
deactivating the active schedule at a specified changeover time in the active interval of a sparse time base; and
activating a new schedule at the specified changeover time in the active interval of the sparse time base.

2. The method according to claim 1, wherein a new passive schedule is loaded whilst an active schedule is executed in the switch.

3. The method according to claim 1, wherein in a number of connected switches, all switches access a common global time base of known precision.

4. The method according to claim 1, wherein the common global time base is fault-tolerant.

5. The method according to claim 1, wherein time-controlled actions in the switch are performed only during the active phases of the global sparse time base.

6. The method according to claim 1, wherein a dynamic on-line scheduler generates a new schedule on the basis of the requirement of a user.

7. The method according to claim 1, wherein the new schedule is loaded into the switch with use of cryptographic protocols to secure the authenticity and integrity of the new schedule by a system that generates the schedule.

8. The method according to claim 1, wherein the scheduler is implemented as a TMR system, wherein a switch only performs a changeover when at least two of three messages received by the TMR system are identical.

9. The method according to claim 1, wherein the schedules are stored in the switch with use of fault-identifying codes.

10. The method according to claim 1, wherein the schedules are stored in the switch with use of fault-correcting codes.

11. The method according to claim 1, wherein the phases of messages that run via a number of switches are synchronised in a schedule with use of the global time, such that a minimal end-to-end transport time of the message through the entire communication system is achieved.

12. The method according to claim 1, wherein the different periods in a schedule are arranged in a harmonic relationship relative to one another such that the longest period is the smallest common multiple of all periods.

13. The method according to claim 1, wherein a distinguished period of the number of harmonic periods corresponds to the physical second.

14. The method according to claim 1, wherein a distinguished period of the quantity of harmonic periods corresponds exactly to an interval that is predefined by an application.

15. The method according to claim 1, wherein in a number of connected switches that have a common global time base, the changeover points of the schedules in all switches are simultaneous.

16. The method according to claim 1, wherein the changeover points are selected such that, with messages that occur in the active and new schedule with the same period, no phase shift is caused by the changeover.

17. The method according to claim 1, wherein the switch checks whether, in a new schedule, messages classified as safety-critical are included in accordance with the safety-critical requirements, and, if this is not the case, the switch does not perform a changeover from the active to the new schedule and transmits a fault message to a diagnosis system.

18. The method according to claim 1, wherein the messages correspond to the SAE standard AS6802 of TT Ethernet.

19. The method according to claim 1, wherein the messages correspond to the IEEE Standard 1588 for precision clock synchronisation.

20. A switch for use in a method according to claim 1.

21. The switch according to claim 20, wherein the switch is configured to deactivate an active schedule and to activate a new schedule at a specified changeover time in the active interval of a sparse time base.

22. A real-time system for carrying out a method according to claim 1.
